(19) United States
(12) Patent Application Publication
(10) Pub. No.: US 2015/0022746 A1
(43) Pub. Date: Jan. 22, 2015

(54) BACKLIGHT DEVICE AND IMAGE DISPLAY APPARATUS USING THE SAME

(71) Applicant: Panasonic Intellectual Property Management Co., Ltd., Osaka (JP)

(72) Inventors: Kouki ICHIHASHI, Osaka (JP); Motonobu YOSHIKAWA, Osaka (JP); Masahiro KASANO, Osaka (JP)

(21) Appl. No.: 14/511,648

(22) Filed: Oct. 10, 2014

Related U.S. Application Data
(63) Continuation of application No. PCT/JP2013/003460, filed on May 31, 2013.

(30) Foreign Application Priority Data
Jun. 1, 2012 (JP) 2012-125729

(51) Int. Cl. G02B 27/22; F21V 8/00

(52) U.S. Cl. CPC G02B 27/2214; G02B 6/0053
USPC 349/15

(57) ABSTRACT

A backlight device and an image display apparatus which are capable of controlling the degree of diffusion of emitted light are provided. The backlight device according to the present disclosure includes: a light source; a light guide plate that causes surface emission of light emitted from the light source; a directivity control film that is provided on a light-emitting side of the light guide plate, and causes the light emitted from the light guide plate to have directivity; and a liquid crystal diffusion element that is switchable between a first state in which the light emitted from the directivity control film is transmitted as it is, and a second state in which the light emitted from the directivity control film is diffused.

### CROSS-REFERENCE TO RELATED APPLICATION

This application is a Continuation of International Application No. PCT/JP2013/003460, filed on May 31, 2013, which claims priority of Japanese Application No. 2012-125729, filed on Jun. 1, 2012, the disclosures of which Applications are incorporated by reference herein.

### BACKGROUND

1. Field

The present disclosure relates to a backlight device used in a liquid crystal display and the like, and an image display apparatus using the backlight device.

2. Description of the Related Art

International Publication WO 2004/027492 discloses a display apparatus including: light sources provided on light-incident surfaces at opposing ends of a light guide plate; a prism sheet provided on a light-emitting surface side of the light guide plate, which prism sheet has triangular prisms extending in a direction parallel to the light-incident surfaces of the light guide plate, and cylindrical lenses extending in parallel to the triangular prism row; and a transmission-type liquid crystal panel provided on a light-emitting surface side of the prism sheet.

The display apparatus is configured such that light from each light source is emitted from the transmission-type display panel at an angle corresponding to a parallax between right and left eyes. A synchronous drive means displays right and left parallax images alternately on the transmission type display panel in synchronization with the light sources, thereby realizing a high-definition stereoscopic view.

### SUMMARY

The present disclosure provides a backlight device capable of controlling the degree of diffusion of emitted light, and an image display apparatus using the backlight device.

A backlight device according to the present disclosure includes: a light source; a light guide plate that causes surface emission of light emitted from the light source; a directivity control film that is provided on a light-emitting side of the light guide plate, and causes the light emitted from the light guide plate to have directivity; and a liquid crystal diffusion element that is switchable between a first state in which the light emitted from the directivity control film is transmitted as it is, and a second state in which the light emitted from the directivity control film is diffused.

An image display apparatus according to the present disclosure includes an image display panel, and the above backlight device provided on a back surface side of the image display panel.

The backlight device and the image display apparatus according to the present disclosure are effective in controlling the degree of diffusion of emitted light.

### BRIEF DESCRIPTION OF THE DRAWINGS

FIG. 1 is a schematic configuration diagram of an image display apparatus according to Embodiment 1;

FIG. 2 is an exploded perspective view of a part of an image display apparatus according to Embodiment 1;

FIG. 3 is a perspective view of a diffusion plate according to Embodiment 1; and

FIG. 4 is a schematic configuration diagram of an image display apparatus according to Embodiment 2.

### DETAILED DESCRIPTION

Hereinafter, embodiments will be described in detail with appropriate reference to the drawings. It is noted that a more detailed description than need may be omitted. For example, the detailed description of already well-known matters and the overlap description of substantially same configurations may be omitted. This is to avoid an unnecessarily redundant description below and to facilitate understanding of a person skilled in the art.

It is noted that the applicant provides the accompanying drawings and the following description in order a person skilled in art to fully understand the present disclosure, and do not intend to limit the subject matter defined by the claims.

### Embodiment 1

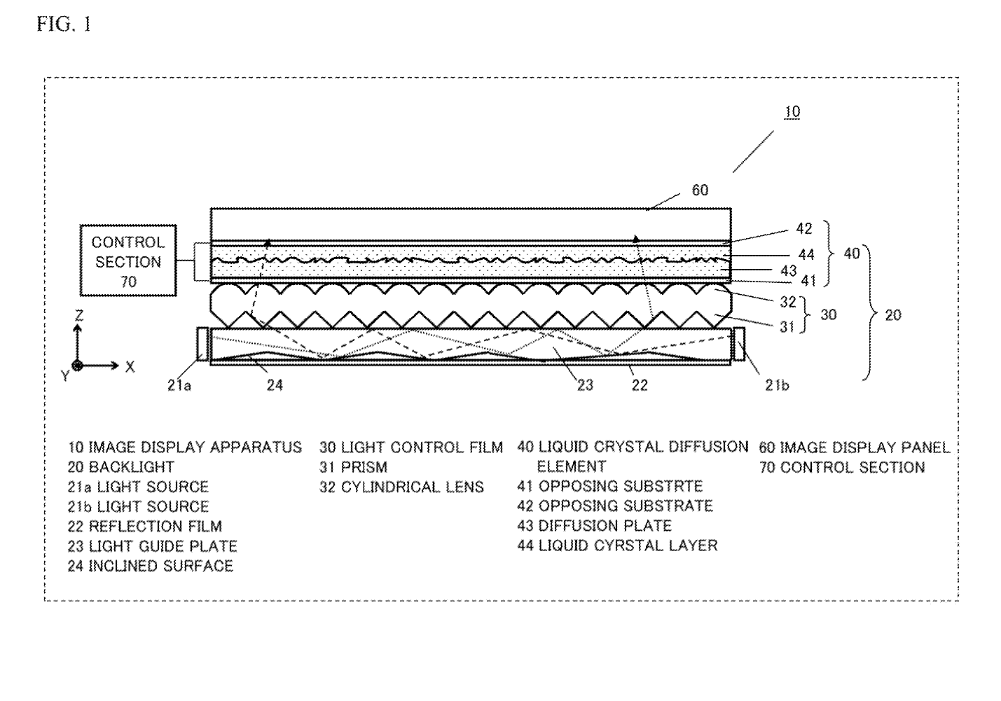

Hereinafter, Embodiment 1 will be described with reference to FIGS. 1 to 3.

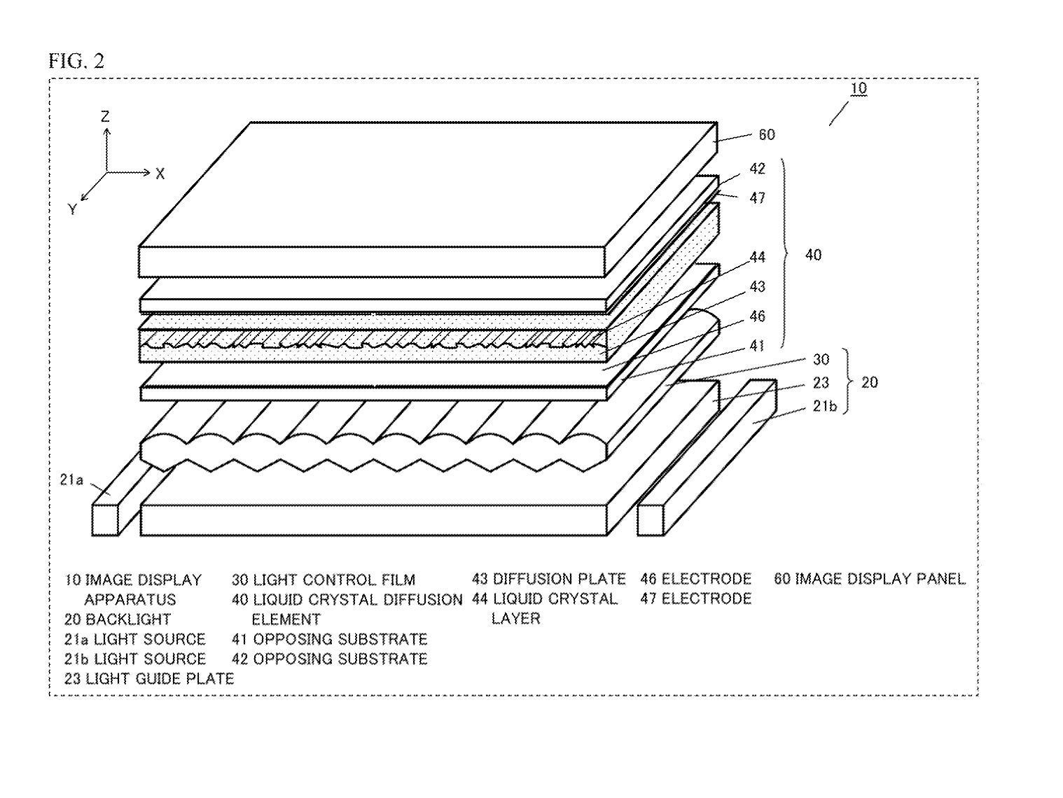

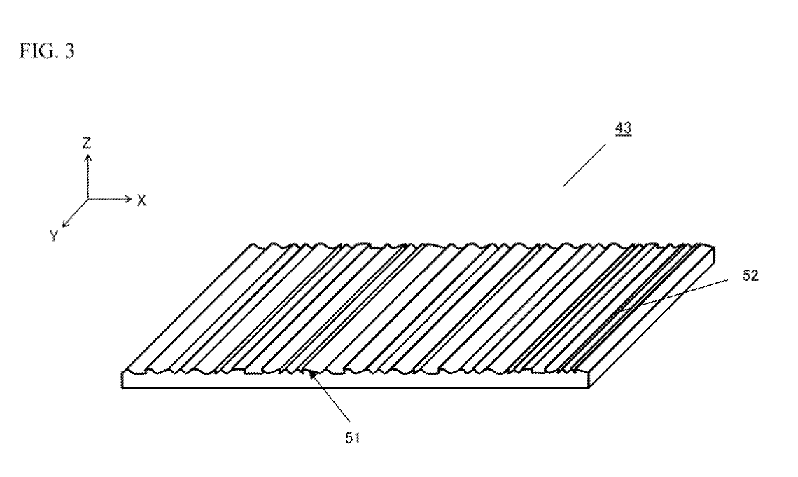

FIG. 1 is a schematic cross-sectional view of an image display apparatus 10 according to Embodiment 1, and FIG. 2 is an exploded perspective view of a part of the image display apparatus 10 shown in FIG. 1. FIG. 3 is a perspective view of a diffusion plate according to Embodiment 1. In FIG. 1, illustration of electrodes 46 and 47 shown in FIG. 2 is omitted.

In the present embodiment, a three-dimensional orthogonal coordinate system is set for the image display apparatus 10, and a direction is specified by using coordinate axes. As shown in FIGS. 1 to 3, an X axis direction coincides with a right-left direction (horizontal direction) when a user faces a display surface of an image display panel 60. A Y axis direction coincides with an up-down direction when the user faces the display surface of the image display panel 60. A Z axis direction coincides with a direction perpendicular to the display surface of the image display panel 60. Here, “facing” means that the user is present directly in front of the display surface such that, for example, when a letter of “A” is displayed on the display surface, the observer sees the letter of “A” from a correct direction. In addition, FIGS. 1 to 3 correspond to views as seen from above the image display apparatus 10. Thus, the left side in FIGS. 1 and 2 corresponds to the right side of the display screen when the user sees the display screen.

The image display apparatus 10 includes a light source switching type backlight 20 (an example of a backlight device), the image display panel 60 capable of displaying a 2D image and a 3D image, and a control section 70 that controls a liquid crystal driving voltage applied to a liquid crystal diffusion element 40. Hereinafter, each component will be described in detail.

The backlight 20 includes light sources 21a and 21b opposing each other, a reflection film 22, a light guide plate 23, a light control film 30, and the liquid crystal diffusion element 40. The reflection film 22 is provided on a lower surface (back surface) side of the light guide plate 23, and the light control film 30 is provided on an upper surface (front surface) side of the light guide plate 23.

The light sources 21a and 21b are arranged so as to extend along a pair of side surfaces, respectively, of the light guide plate 23, and oppose each other in the X axis direction. The light source 21a is located at the left side surface of the light guide plate 23, and the light source 21b is located at the right side surface of the light guide plate 23. Each of the light sources 21a and 21b has a plurality of LED elements arranged in the Y axis direction. When a 3D image is displayed, each of the light sources 21a and 21b alternately repeats lighting-up and going-out in synchronization with switching between an image for right eye and an image for left eye that are displayed on the image display panel 60. In other words, when the image display panel 60 displays the image for right eye, the light source 21a lights up and the light source 21b goes out, and when the image display panel 60 displays the image for left eye, the light source 21a goes out and the light source 21b lights up. When a 2D image is displayed, the same image is displayed on the image display panel 60 both when the light source 21a lights up and when the light source 22a lights up.

Light emitted from the light sources 21a and 21b spreads in the light guide plate 23 while being repeatedly totally reflected at the upper surface and the lower surface of the light guide plate 23. Light having an angle exceeding the total reflection angle within the light guide plate 23 is emitted from the upper surface of the light guide plate 23. The lower surface of the light guide plate 23 is composed of a plurality of inclined surfaces 24 as shown in FIG. 1. By these inclined surfaces 24, the light propagating in the light guide plate 23 is reflected in various directions, and thus the intensity of the light emitted from the light guide plate 23 becomes uniform across the entire upper surface.

The reflection film 22 is provided on the lower surface side of the light guide plate 23. Light having an angle exceeding the total reflection angles of the inclined surfaces 24 provided in the lower surface of the light guide plate 23 is reflected by the reflection film 22, enters the light guide plate 23 again, and is eventually emitted from the upper surface. The light emitted from the light guide plate 23 enters the light control film 30.

On a lower surface of the light control film 30, a plurality of prisms 31 each having a triangular cross section and a ridge line extending in the Y axis direction are aligned along the X axis direction. In other words, on the lower surface of the light control film 30, the prisms 31 each having a triangular cross section are arranged in a one-dimensional array. In addition, on an upper surface of the light control film 30, a plurality of cylindrical lenses 32 extending in the Y axis direction are arranged in parallel along the X axis direction. In other words, a lenticular lens is formed on the upper surface of the light control film 30.

The light incident on the lower surface of the light control film 30 is refracted toward the Z axis direction by the prisms 31, and directivity of the light is controlled by the cylindrical lens 32 on the upper surface of the light control film 30. When the user views a 3D image, the light from the light source 21a is converged on the right eye of the user, and the light from the light source 21b is converged on the left eye of the user. At this time, the image display panel 60 displays the image for right eye when the light source 21a lights up, and displays the image for left eye when the light source 21b lights up, and thus the user can view the 3D image.

The light emitted from the light control film 30 enters the liquid crystal diffusion element 40.

The liquid crystal diffusion element 40 includes at least a diffusion plate 43 as a first optical element, and a liquid crystal layer 44 as a second optical element. More specifically, the liquid crystal diffusion element 40 includes a pair of opposing substrates 41 and 42, the diffusion plate 43 and the liquid crystal layer 44 sealed between the opposing substrates 41 and 42, an electrode 46 provided on an inner surface of the opposing substrate 41, an electrode 47 provided on an inner surface of the opposing substrate 42, an alignment film (not shown) provided on a light-emitting surface of the diffusion plate 43, and an alignment film (not shown) provided on a light-incident surface side of the substrate 42. In addition, polarizers (not shown) for causing polarization directions of incident light and emitted light to be identical are provided on outer surfaces of the opposing substrates 41 and 42, respectively. In the present embodiment, the transmission axes of the polarizers extend in the Y axis direction. In other words, light of components in polarization directions other than the Y axis direction is absorbed.

As shown in FIG. 3, a plurality of projections having a plurality of ridge lines 52 extending in parallel to the Y direction are provided on the surface of the diffusion plate 43. Therefore, the interface between the diffusion plate 43 and the liquid crystal layer 44 is a rough surface 51 at the X-Z section, and is linear at the Y-Z section. Thereby, when there is a difference in refractive index between the diffusion plate 43 and the liquid crystal layer 44, the light traveling from the diffusion plate 43 to the liquid crystal layer 44 is diffused in the X axis direction at the interface between the diffusion plate 43 and the liquid crystal layer 44. As a result, the light emitted from the liquid crystal diffusion element 40 is diffused in the X axis direction in accordance with the difference in refractive index between the diffusion plate 43 and the liquid crystal layer 44.

The control section 70 switches the value of the voltage applied to the liquid crystal diffusion element 40 depending on which of the 2D image and the 3D image is viewed. When the 3D image is viewed, the control section 70 controls the magnitude of the voltage applied to the liquid crystal layer 44 so that the refractive indexes of the diffusion plate 43 and the liquid crystal layer 44 are substantially equal to each other. When the 2D image is viewed, the control section 70 applies no voltage to the liquid crystal layer so that the difference in refractive index between the diffusion plate 43 and the liquid crystal layer 44 is increased. By controlling the applied voltage in this way, when the 3D image is viewed, the light emitted from the light control film 30 enters the image display panel 60 while maintaining the directivity thereof. On the other hand, when the 2D image is displayed, the light emitted from the light control film 30 is diffused by the liquid crystal diffusion element 40 and enters the image display panel 60.

The alignment films provided on the light-emitting surface of the diffusion plate 43 and the light-incident surface of the substrate 42 orient liquid crystal molecules such that the long axes of the liquid crystal molecules extend in the Y axis direction in a state where no voltage is applied to the electrodes 46 and 47. However, these alignment films may be omitted as long as the orientations of the liquid crystal molecules are kept uniform.

As the materials of the opposing substrates 41 and 42 and the diffusion plate 43, glass or resin can be used. When resin is used as the material of the diffusion plate 43, the diffusion plate 43 can be formed by, as an example, imprinting a UV-curing resin on a glass substrate. The liquid crystal diffusion element 40 can be produced by forming the diffusion plate 43 on the opposing substrate 41 on which the electrode 46 is formed, then attaching together the opposing substrate 41 and the opposing substrate 42 on which the electrode 47 is formed, and injecting a liquid crystal between the opposing substrates 41 and 42.

As described above, the liquid crystal diffusion element 40 is an element that can control the degree of diffusion of transmitted light by controlling the voltage applied from the outside. The principle will be described briefly. In general, a liquid crystal molecule has an ellipsoidal shape and has different dielectric constants in the longitudinal direction and the lateral direction thereof. Therefore, the liquid crystal layer 44 has a birefringence property in which a refractive index is different for each polarization direction of incident light. In addition, when the direction of the longitudinal orientation (director) of each liquid crystal molecule relatively changes with respect to the polarization direction of light, the refractive index of the liquid crystal layer 44 also changes. Therefore, when the orientation of the liquid crystal is changed by an electric field generated by applying a certain voltage, the refractive index for the transmitted light changes, and thus diffusibility of the light changes.

In the present embodiment, a case will be considered where uniaxial positive type liquid crystal is used as the material forming the liquid crystal layer 44. Then, a case will be considered where the longitudinal axis of the liquid crystal molecules is oriented in the Y axis direction when no voltage is applied between the opposing electrodes, and the longitudinal axis of the liquid crystal molecules is oriented in the Z axis direction when a voltage is applied.

Since the transmission axis of the polarizers extends in the Y axis direction, the refractive index of the liquid crystal layer 44 when no voltage is applied is an extraordinary light refractive index, and the refractive index of the liquid crystal layer 44 when a voltage is applied is an ordinary light refractive index.

In the case where light is diffused by an active element such as the liquid crystal diffusion element 40, it is desirable to use a liquid crystal material having high An (=refractive index ne for extraordinary light—refractive index no for ordinary light), in order to increase the diffusion angle. However, among commercially available materials, the number of liquid crystal materials having high An is small, and An is generally about 0.2.

In the present embodiment, the refractive index of the diffusion plate 43 is set to 1.5, the refractive index of the liquid crystal layer 44 for ordinary light is set to 1.5, and the refractive index of the liquid crystal layer 44 for extraordinary light is set to 1.7. The control section 70 performs control such that a voltage is applied to the electrode when the 3D image is viewed, and no voltage is applied to the electrode when the 2D image is viewed. Thus, when the 3D image is viewed, the light incident on the liquid crystal diffusion element 40 passes therethrough without being subjected to the diffusion effect. When the 2D image is viewed, the light traveling through the liquid crystal diffusion element 40 is diffused.

In addition, even when the liquid crystal diffusion element 40 is formed using the same liquid crystal material, design of the orientation direction and a manner of applying an electric field are important items that have a great influence on the element performance, which is the ability of the liquid crystal diffusion element 40, such as a diffusion angle, electric power, a switching speed, and the like.

The light transmitted through the liquid crystal diffusion element 40 enters the image display panel 60. As an example of the image display panel 60, an In-Plane-Switching panel may be used. However, another type of image display panel may be used as the image display panel 60. When the 3D image is displayed, the light transmitted through the image display panel 60 is not diffused by the liquid crystal diffusion element 40 and therefore has directivity, and is converged on the position of the user's eye. At this time, the image display apparatus 10 performs switching between the light sources 21a and 21b in synchronization with switching between the image for right eye and the image for left eye. In addition, when the switching between the image for right eye and the image for left eye is performed at a frequency equal to or higher than 120 Hz, the user can recognize a stereoscopic image without having a sense of discomfort, based on the image for right eye and the image for left eye.

On the other hand, when the 2D image is viewed, the light diffused by the liquid crystal diffusion element 40 enters the image display panel 60. Therefore, the light transmitted through the image display panel 60 has a wide light distribution, and the user can view the image with a wide range. When the 2D image is viewed, the image display panel 60 displays the same image having no parallax both when the light source 21a lights up and when the light source 21b lights up.

As described above, in the present embodiment, when the 3D image is viewed, the light emitted from the directivity control film 20 is transmitted as it is, the image light for right eye is converged on the user's right eye while the image light for left eye is converged on the user's left eye. Thereby, the user can view an image having high brightness. On the other hand, when the 2D image is viewed, since the light emitted from the directivity control film 20 is diffused, the light transmitted through the image display panel 60 is distributed at a wide angle. Thereby, the user can view the 2D image with a wide range of viewing field. In addition, a plurality of users can view the 2D image at the same time.

In the above embodiment, an example has been described in which the refractive index of the diffusion plate 43 is set to 1.5, the refractive index of the liquid crystal layer 44 when a voltage is applied is set to 1.5, and the refractive index of the liquid crystal layer 44 when no voltage is applied is set to 1.7. In this example, when a voltage is applied, the difference in refractive index between the diffusion plate 43 and the liquid crystal layer 44 is substantially zero, and the liquid crystal diffusion element 40 transmits the incident light (first state). On the other hand, when no voltage is applied, the difference in refractive index between the diffusion plate 43 and the liquid crystal layer 44 becomes larger than that in the case where a voltage is applied, and the liquid crystal diffusion element 40 diffuses the incident light (second state).

Instead of this configuration, for example, the refractive index of the diffusion plate 43 may be set to 1.7, the refractive index of the liquid crystal layer 44 when a voltage is applied may be set to 1.5, and the refractive index of the liquid crystal layer 44 when no voltage is applied may be set to 1.7. In this example, when no voltage is applied, the difference in refractive index between the diffusion plate 43 and the liquid crystal layer 44 is substantially zero, and the liquid crystal diffusion element 40 transmits the incident light (first state). On the other hand, when a voltage is applied, the difference in refractive index between the diffusion plate 43 and the liquid crystal layer 44 becomes larger than that in the case where no voltage is applied, and the liquid crystal diffusion element 40 diffuses the incident light (second state). That is, it is sufficient when the difference in refractive index between the diffusion plate 43 and the liquid crystal layer 44 may be substantially zero in one of the state where a voltage is applied and the state where no voltage is applied, and the difference in refractive index between the diffusion plate 43 and the liquid crystal layer 44 may be increased in the other state.

### Embodiment 2

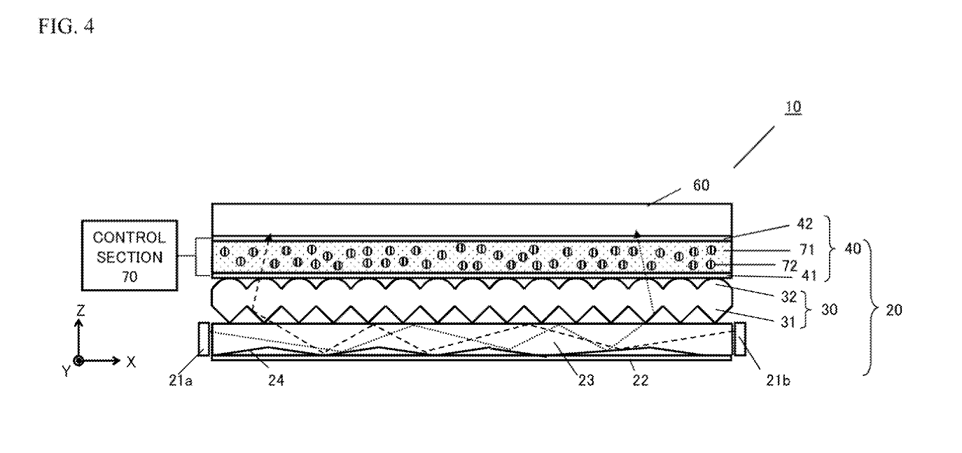

FIG. 4 is a schematic configuration diagram of an image display apparatus according to Embodiment 2.

A liquid crystal diffusion element 40 according to Embodiment 2 includes a pair of opposing substrates 41 and 42, a base material 71 and liquid crystal capsules 72 sealed between the opposing substrates 41 and 42, an electrode (not shown) provided on an inner surface of the opposing substrate 41, and an electrode (not shown) provided on an inner surface of the opposing substrate 42. The base material 71 as a first optical element is a polymer matrix having a network structure, and the liquid crystal capsules 72 as a second optical element are a plurality of liquid crystal drops dispersing in the network structure of the base material 71. The base material 71 and the liquid crystal capsules 72 form a polymer dispersed liquid crystal element. The polymer dispersed liquid crystal element can be fabricated by any of the following methods: a solution casting method in which a polymer and a liquid crystal are dissolved in a common solvent, and the resultant solution is cast on a substrate; an impregnation method in which a liquid crystal is impregnated in pores of a porous polymer film; an emulsification method in which a liquid crystal is emulsified and dispersed in a polymer solution, and the emulsified/dispersed solution is cast; and a polymerization method in which a uniform solution containing a liquid crystal and a polymerizable monomer is prepared, and this solution is phase-separated by polymerization to form a phase separation structure.

When a predetermined voltage is applied between the electrodes provided on the inner surfaces of the opposing substrates 41 and 42, the orientations of liquid crystal molecules in the liquid crystal capsules 72 are made uniform. Therefore, the refractive index of the liquid crystal capsules 72 in the state where the voltage is applied between the electrodes is smaller than the refractive index of the liquid crystal capsules 72 in the state where no voltage is applied between the electrodes. Therefore, it is possible to increase the degree of light diffusion due to the liquid crystal diffusion element 40 by making the difference in refractive index between the base material 71 and the liquid crystal capsules 72 in the state where no voltage is applied to the liquid crystal diffusion element 40, larger than the difference in refractive index between the base material 71 and the liquid crystal capsules 72 in the state where the voltage is applied to the liquid crystal diffusion element 40.

For example, the refractive index of the base material 71 is set to 1.5, the refractive index of the liquid crystal capsules 72 in the state where the voltage is applied is 1.5, and the refractive index of the liquid crystal capsules 72 in the state where no voltage is applied to set to 1.6. Then, the control section 70 performs control such that the voltage is applied to the electrodes when the 3D image is viewed while no voltage is applied to the electrodes when the 2D image is viewed. Thus, when the 3D image is viewed, the light incident on the liquid crystal diffusion element 40 passes therethrough without being subjected to the diffusion effect. When the 2D image is viewed, the light traveling through the liquid crystal diffusion element 40 is diffused. By this configuration, the directivity of the emitted light from the light control film 30 can be optimized for 3D image viewing, and when the 2D image is viewed, viewing with a wider range or viewing for a plurality of viewers can be realized.

### Other Embodiments

While in the above embodiments the light guide plate is shared by the light sources 21a and 21b. However, a light guide plate for the light source 21a and a light guide plate for the light source 21b may be provided so as to be laminated on each other.

In addition, instead of the control film 30 in which the prisms and the lenticular lens are integrated, a prism sheet and a lenticular lens sheet may be individually provided.

Furthermore, the configuration of the backlight 20 is not limited to that shown in FIGS. 1, 2 and 4, and may have another configuration as long as it can alternately emit light for right eye and light for left eye in a time division manner in synchronization with switching between right and left image signals.

While in the above embodiments the 2D image is displayed in synchronization with lighting-up of the light source 21a and the light source 21b when the 2D image is viewed, the light source 21a and the light source 21b may be constantly lit up. In this case, timing to light up the light sources need not be synchronized with the frequency of the image, and thereby a brighter image can be obtained.

While in the above embodiments the light sources 21a and 21b are used as the first and second light source units, a single light source may be used when the present disclosure is applied to an image display apparatus dedicated for 2D image.

While in the above embodiments no voltage is applied to the liquid crystal diffusion element when the 2D image is viewed, a voltage smaller than the voltage applied when the 3D image is viewed may be applied to reduce the degree of light diffusion. In this case, the light distribution is reduced and the viewing range of the user is reduced, but higher brightness is achieved and thereby the user can view a brighter image. Accordingly, the user can view the 2D image with his/her desired light distribution.

Further, in Embodiment 1, the refractive index of the diffusion plate 43 and the refractive index of the liquid crystal layer 44, in the state where a voltage is applied, are made equal to each other. In order to cause the light incident on the liquid crystal diffusion element 40 to transmit as it is, it is ideal that the difference in refractive index between the diffusion plate 43 and the liquid crystal layer 44 is zero. However, unless the directivity of the light control film 30 is greatly changed, influence on the 3D image viewing is restrictive even if there is a slight difference between the refractive index of the diffusion plate 43 and the refractive index of the liquid crystal layer 44. Accordingly, it is sufficient when, at least, the difference in refractive index between the diffusion plate 43 and the liquid crystal layer 44 under the light diffused state is larger than the difference in refractive index between the diffusion plate 43 and the liquid crystal layer 44 under the light transmitted state, and it is preferable that the refractive index of the diffusion plate 43 and the refractive index of the liquid crystal layer 44 under the light diffused state are substantially equal to each other.

Also in Embodiment 2, for the same reason as above, there may be a slight difference between the refractive index of the base material 71 and the refractive index of the liquid crystal capsules 72 unless the directivity of the light control film 30 is greatly changed. Accordingly, it is sufficient when, at least, the difference in refractive index between the base material 71 and the liquid crystal capsules 72 in the light diffused state is larger than the difference in refractive index between the base material 71 and the liquid crystal capsules 42 in the light transmitted state, and it is preferable that the refractive index of the base material 71 and the refractive index of the liquid crystal capsules 72 in the light diffused state are substantially equal to each other.

Further, while in the above embodiments the values of the refractive indexes of the diffusion plate 43, the liquid crystal layer 44, the base material 71, and the liquid crystal capsules 72 are specified, the values of the refractive indexes of these portions are appropriately variable depending on the intended use of the backlight 20 and the image display apparatus 10.

Further, in the above embodiments, the configuration has been described in which the incident light is transmitted in the state where a voltage is applied, and the incident light is diffused in the state where no voltage is applied. However, the refractive indexes of the diffusion plate 43, the liquid crystal layer 44, the base material 71, and the liquid crystal capsules 72 may be selected so that the incident light is diffused in the state where a voltage is applied, and transmitted in the state where no voltage is applied.

Further, the backlight 20 according to each of the above embodiments may be applied not only to the image display apparatus capable of displaying a 2D image and a 3D image but also to an image display apparatus capable of displaying a 2D image only. In this case, since the degree of light diffusion can be varied depending on the number of viewers, power consumption can be reduced when the number of viewers is small.

Further, the liquid crystal diffusion element 40 may be combined with a light guide plate having directivity of emitted light to form a backlight, or may be combined with a light guide plate that emits light having no directivity due to irregular reflection, and a prism sheet to form a backlight.

While in the above embodiments the form of the liquid crystal existing in the liquid crystal diffusion element 40 is specified, the present disclosure is not limited thereto. It is sufficient when a first optical element composed of a part where liquid crystal molecules exist and a second optical element composed of a part where another medium exists are separated via an interface between a pair of opposing electrodes, the interface between the first optical element and the second optical element does not form at least a plane surface, and a difference in refractive index between the first optical element and the second optical element is varied by a voltage being applied.

While in Embodiment 2 the liquid crystal capsules 72 having a circular cross section are shown (FIG. 4), the liquid crystal capsules 72 may be liquid crystal drops having another cross-sectional shape such as ellipse.

The present disclosure is applicable to an image display apparatus capable of displaying a 2D image and a 3D image, an image display apparatus capable of displaying a 2D image, a privacy display, and the like.

As presented above, the embodiments have been described as examples of the technology according to the present disclosure. For this purpose, the accompanying drawings and the detailed description are provided.

Therefore, components in the accompanying drawings and the detail description may include not only components essential for solving problems, but also components that are provided to illustrate the above described technology and are not essential for solving problems. Therefore, such inessential components should not be readily construed as being essential based on the fact that such inessential components are shown in the accompanying drawings or mentioned in the detailed description.

Further, the above described embodiment has been described to exemplify the technology according to the present disclosure, and therefore, various modifications, replacements, additions, and omissions may be made within the scope of the claims and the scope of the equivalents thereof

What is claimed is:

1. A backlight device comprising:
a light source;
a light guide plate that causes surface emission of light emitted from the light source;
a directivity control film provided on a light-emitting side of the light guide plate, the directivity control film causing the light emitted from the light guide plate to have directivity; and
a liquid crystal diffusion element composed of a diffusion plate and a liquid crystal layer provided on the diffusion plate, wherein
the liquid crystal diffusion element is switchable between a first state in which the light emitted from the directivity control film is transmitted as it is, and a second state in which a difference in refractive index between the diffusion plate and the liquid crystal layer is larger than that in the first state, and the light emitted from the directivity control film is diffused.

2. The backlight device according to claim 1, wherein
in the second state, the refractive index of the liquid crystal layer is larger than the refractive index of the diffusion plate.

3. The backlight device according to claim 2, wherein
in the first state, the refractive indexes of the diffusion plate and the liquid crystal are substantially equal to each other.

4. The backlight device according to claim 1, wherein
the diffusion plate includes a plurality of ridge lines at an interface between the diffusion plate and the liquid crystal layer, the ridge lines extending in a direction perpendicular to a direction in which a pair of the light sources oppose each other.

5. The backlight device according to claim 1, wherein
the light source includes a first light source unit and a second light source unit that are provided so as to oppose each other at a pair of opposing side surfaces of the light guide plate, and are capable of alternately lighting up and going out.

6. An image display apparatus comprising:
an image display panel; and
the backlight device according to claim 1, provided on a back surface side of the image display panel.
